(19) United States
(12) Patent Application Publication
(10) Pub. No.: US 2011/0017932 A1
(43) Pub. Date: Jan. 27, 2011

(54) MONOBLOCK BALL VALVE AND MANUFACTURE METHOD THEREOF

(76) Inventor: Arnaldo Domingues Matos, Marinha Grande (PT)

Correspondence Address: KENEALY VAIDYA LLP, 515 EAST BRADDOCK RD SUITE B, Alexandria, VA, 22314, US

(21) Appl. No.: 12/921,371

(22) PCT Filed: Mar. 7, 2008
(86) PCT No.: PCT/PT08/00011

§ 371 Date: Oct. 15, 2010

(51) Int. Cl. F16K 5/06; B29C 45/00; B29C 45/14; B29C 70/04

(52) U.S. Cl. 251/315.16; 264/250; 264/46.4

(57) ABSTRACT

A manufacture method of monoblock ball valve is based on overmoulding techniques and integral assembly of plastic components inside the injection moulds, in a sequential manufacturing process, wherein the component which is injected in the first stage of the process will be sequentially introduced in moulds which will in turn inject other components, thus resulting in the end in a single body that ensures the functional features of a piece obtained by several components' assembly. The hydraulic ball valve according to the invention comprises at least the following components: a ball filling element or valve filling core with a valve control stem,—a ball that involves the ball filling element; a sleeve-type sealing element, which covers the entire ball and the whole interior part of the valve body, and a valve body.

### FIELD OF THE INVENTION

The present invention relates to a monoblock ball valve manufactured in thermoplastic material by injection moulding methods. The innovations described will focus mainly on the body of the monoblock valve, as well as on the improvements to exclude some deficiencies detected in the valves currently available in the market. The body of the valve will consist of a single solid block.

The Valve presents a set of technical innovations to improve the product's functionality, which includes establishing improvements on the conception of the valve's ball, integrating a single sealing element in the product (presently inexistent), the functional improvement of the valve's fast coupling system to the tube, reducing the number of valve components as well as the material applied in all components. Moreover, an alternative is also considered concerning the introduction of valve reinforcements, whose function is to increase the valve's resistance against pressure and to decrease the effect of volumetric contraction resulting from the cooling of the plastic, whilst the body injection onto the remaining valve components.

One of the most efficient techniques of processing plastic material is assuredly the injection moulding. The process consists of heating up a plastic material to its melting point, in a cylinder surrounded by thermal resistances. Inside the warm cylinder operates a spindle, which “chews” the material when under rotation pushing it to the front area of the cylinder. Afterwards, the material will be injected by the relocation movement of the spindle that forces the melted plastic material inside the mould cores, wherein the material is worked up and wherein it cools down assuming its final shape. Finally, the mould opens and the plastic piece is extracted. The process enables extremely high productive cadencies, with enhanced reproductiveness and consistence, being the most efficient process for the production of high-complexity plastic pieces.

The overmoulding has been already used in other products' manufacture, but not in this type of products or at least not with this purpose. Cases of similar products are known wherein the manual or automated systems are used to apply sealings and/or other components, on which the body is later injected, presenting however different results in product quality being consequently hardly compared to the present process and product.

Besides the innovations in the manufacture method, the present document further foresees the solutions to:
compensate deficiencies in sealing valves which are assembled with accessories for fast coupling to the tube;
obtain a uniform roundness around the ball so that a perfect sealing is obtained;
increase the valve's resistance to high-pressure

### BRIEF DESCRIPTION OF THE DRAWINGS

Many of the aspects of the invention can be better understood with reference to some drawings thereof. The components in the drawings are not necessarily to scale, being instead emphasised the clear illustration of the principles inherent to the present invention. The drawings are non-limitative and aim mainly to a clearer understanding of the following description:

FIG. 1 shows a sectional three-dimensional perspective view of an embodiment of the ball valve according to the invention;

FIG. 2 shows a side sectional view of an embodiment of the ball valve according to the invention;

FIG. 3 shows a side sectional view of a valve of the state of the art;

FIG. 4 shows three-dimensional perspective views of the central components of the ball valve according to the invention;

FIG. 5 shows a perspective view of the ball filling element or ball filling core;

FIG. 6 shows a sectional perspective view of the ball with the core-filling element;

FIG. 7 shows a sectional perspective view of the single sealing element (3) and the remaining components;

FIG. 8 shows a perspective view of the single sealing element (3) and the remaining components;

FIG. 9 shows a cross-sectional perspective view of the valve with a particle filter (20) which is placed inside the valve;

FIG. 10 shows a perspective view of the valve body (4) and the remaining components;

FIG. 11 shows sectional and non-sectional three-dimensional perspective views of the process of sequential injection showing the overmoulding stages;

FIG. 12 shows sectional three-dimensional perspective views of the core filling element, of the core filling element and the ball, and of the integration of both inside a component obtained with aid of an expander;

FIG. 13 shows three sectional three-dimensional perspective views for three positions of the ball valve: totally open (A), half open (B) and closed (C);

FIGS. 14a, 14b and 14c show three sectional three-dimensional perspective views of the rotational system of the ball inside the mould of the valve body;

FIG. 15 shows the partition line (x) of the moulds marked in a ball (2) and in a cross section of the valve;

FIGS. 16a and 16b show the perspective views of the placement process of the internal reinforcement element which does not allow an excessive contraction of the sealing;

FIG. 17 shows a set perspective view enhancing the sealing points in the connectors' area and in the upper area of the valve stem;

FIGS. 18a, 18b, and 18c show the side sectional set views of the system's clamping sequence comprising a fast coupling on the right side and a coupling with a thermal welding connector (40) on the left side;

FIG. 19 shows a perspective view of the tube clamping element (12) and the abutment element of the sealing;

FIGS. 20a and 20b show perspective views of a metal washer for the tube clamping element;

FIG. 21 shows a perspective view of the set;

FIG. 22 shows a perspective view of the provided valve and nut socket wrench thereof;

FIGS. 23a, 23b and 23c show front views (explosion) of all components of the ball valves, both in most conventional concept and in the proposed new concept;

FIG. 24 shows a front view of a conventional ball valve and of the new ball valve;

FIG. 25 shows a perspective view of an anti-particle filter.

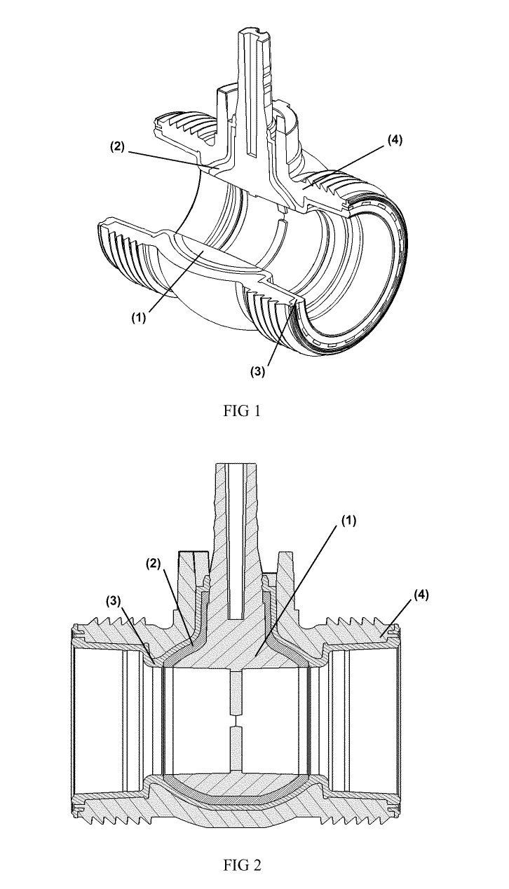

### BACKGROUND OF THE INVENTION

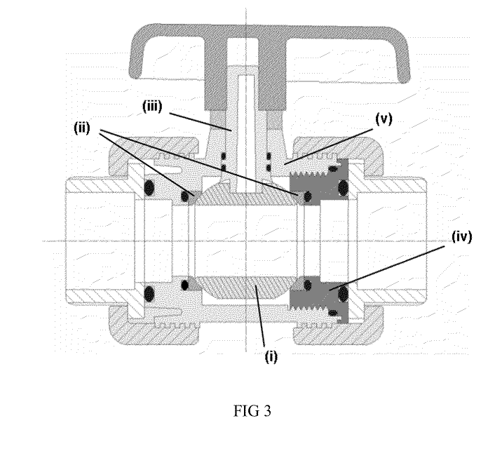

The ball valves are well known and normally include the following components: (i) ball, (ii) ball sealings or ball seat, (iii) ball actuator or ball stem, (iv) body cover, (v) valve body, as well as other accessories for the connection of the same to hard or flexible tubes, as shown in FIG. 3.

This object is used for providing a flow restriction or interruption of any kind of liquid substance flowing along a tube section. These valves allow a liquid flow variation, due to the position deviation of the ball.

This flow restriction takes place because, when rotating the ball, the ball opening for the passage of the liquid reduces gradually, till reaching a closed position, wherein the flow ceases due to the obstruction of the liquid stream.

In conventional thermoplastic ball valves all components are separately moulded and subsequently assembled to form the final product. In this case, since there's a need for setting up the components of the valve's core, there is also the need of an additional component, meaning the body cover (iv) to allow the assembly of the ball (i), of the sealings (ii) and of the ball's actuator (iii) inside the same.

Another important characteristic in conventional ball valves is that, in order to obtain a good sealing, the ball (i) necessarily requests a surface finishing procedure aiming for the removal of possible contrasting contractions, edges or other defects that might compromise its roundness and might eventually cause leakage.

Another characteristic inherent to these conventional valves is the large number of components that integrate the whole set. Generally, the set consists of 18 elements, 7 of which being o-ring or joint rings of circular section.

U.S. Pat. No. 4,705,058 describes a ball valve with a plastic body manufactured around a fine metal cylinder. Although this document discloses an injection valve, the presence of the metal cylinder leads to a heavier and more inflexible valve than the one disclosed in the present request.

U.S. Pat. No. 4,553,562 discloses a ball valve comprising a resin valve body, whose box is set up by moulding. In this case the valve body is previously mounted unlike the valve of the present application.

U.S. Pat. No. 4,180,542 discloses a construction method of a ball valve by overmoulding wherein the several types of moulds used therein are described. Concerning the present document the application foresees not only a different moulding cycle, but also a different construction of the ball and the single sealing element that involves the whole ball, as well as totally different coupling systems.

### DESCRIPTION OF THE INVENTION

Although the ball valve is already frequently applied in water pipe systems, the search for a solution of functional integration of some of its components in a simpler plastic system, or even the elimination or substitution of some of its components, supports an interesting opportunity to overcome in the market, with a highly innovative product as far as design and functional integration are concerned, being obtained by a highly automated and innovative manufacture process.

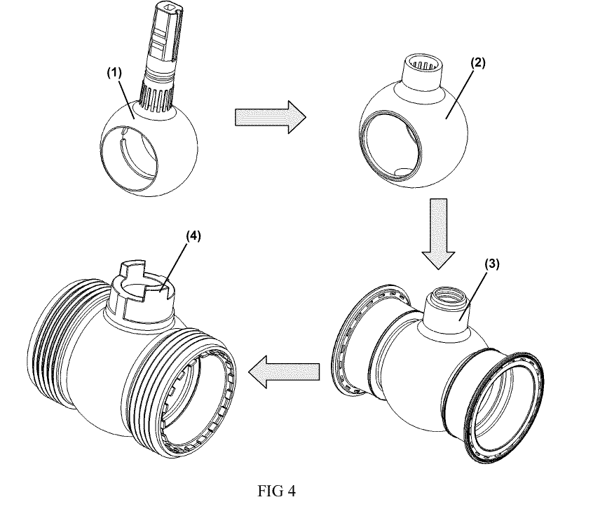

The ball valve according to the present invention comprises at least the following pieces (see FIG. 4):

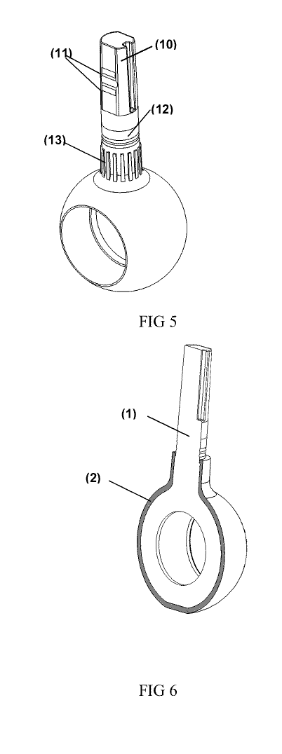

A ball filling element or a ball filling core (1) with a valve control stem which is essentially spherical-shaped comprising a cylindrical channel whose axis crosses the ball centre and it is essentially perpendicular to the axis of the control stem;
A ball (2) with a hollow spherical shape that involves the ball filling element (1), preferably presenting a uniform thickness of 2.5-3 mm;
a sleeve-type single sealing element (3), that covers the ball (2) completely as well as the interior of the valve body, comprising two cylindrical section openings which correspond to the inlet outlet areas of the valve body (4). The said sleeve further comprises an opening in the area surrounding the stem's diameter; and
A valve body (4) with an essentially hollow cylindrical shape comprising the inlet and outlet areas in its ends and a radial opening in the middle of the body for the rolling movement of the stem, wherein both inlet and outlet areas comprise coupling means to the tube.
The ball filling element (1) or core is a spherical component with an opening for the liquid flow, also integrating the spur (spike) of the valve control handle, designated stem. The element presents on the side of the stem (circular area) a placement slot (10) to assemble the handle (39). In the plane walls of the stem, fitting/clamping lumps (11) are provided enabling the handle (39) to fit with a click. In the stem base two half-round grooves (12) are provided wherein the sealing of the single sealing element (3) is carried out. The component further presents fixing ribs (13) with the purpose to mechanically fix the component which is thereon overmoulded
the ball (2), see FIG. 5;
The ball (2) is basically a skin-type cover that intends to eliminate any superficial imperfection that might occur in the ball. It has a reduced and uniform thickness, thus avoiding some typical defects inherent to the injection of highly thick components, such as: warpage, voids or sink marks, etc. The objective is to provide a perfectly spherical ball presenting a surface quality that allows its good rotation and a perfect sealing between the said ball and the sealing element. The ball's geometry is mainly characterized by an uniform thickness of 2.5 mm to 3 mm, since this thickness range enables the component to a better adjustment of the injection process. In the injection moulding process, there is a set of factors that might be decisive in the high quality of our final product. Therefore, by means of components with thin and uniform wall thickness it will be easier to obtain good quality products both on a dimensional/geometric perspective and on a visual aspect/superficial quality level. The afore-mentioned typical defects of injection are usually avoided when plastic pieces with thin and uniform wall are projected, always bearing in mind the ratio between component wall and mechanical behaviour, see FIG. 6;
The single sealing element (3) that totally involves the ball and the interior of the valve body (4), also upholds the sealing in the stem area (b) and abutment area of the connectors (a). Its geometry was conceived to involve the whole ball, sealing the abutment area of the opening (c) and extending outside the valve body in order to promote the sealing in the valve stem area (b) and in the abutment area of the connectors that bond the tube (a), see FIG. 7. In those areas, the geometry presents some lumps that increase the contact area, allow a larger deformation of the rubber, thus improving the abutment of the components and promoting a better sealing.

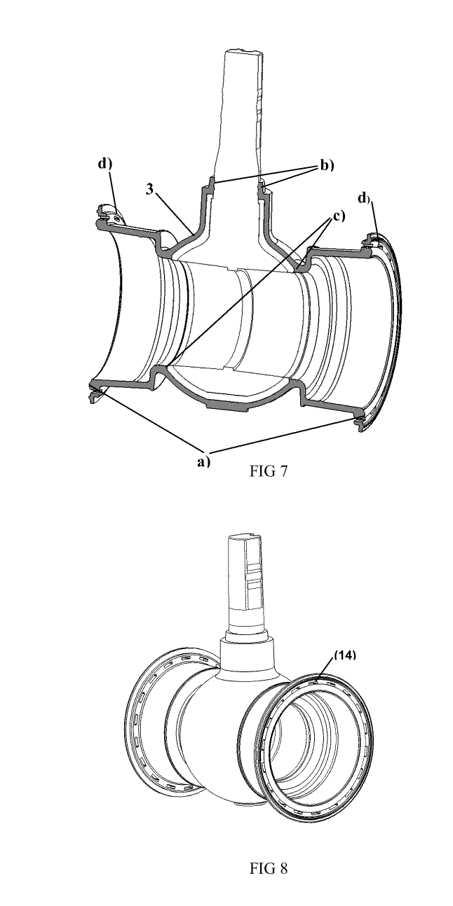

Since the sealing material does not have affinity with the material composing the remaining components, it is possible for the ball to rotate inside the valve. It is however important to promote the mechanical fixation of the sealing to the valve body and for that end, fixing slots were made (14) in the sealing ends, see also FIG. 8.

It is also important to point out a small half-round bulge (6) that is projected inside the sealing and undertakes the task to retain the particle filter (5) which can be placed inside the valves, see FIG. 9.

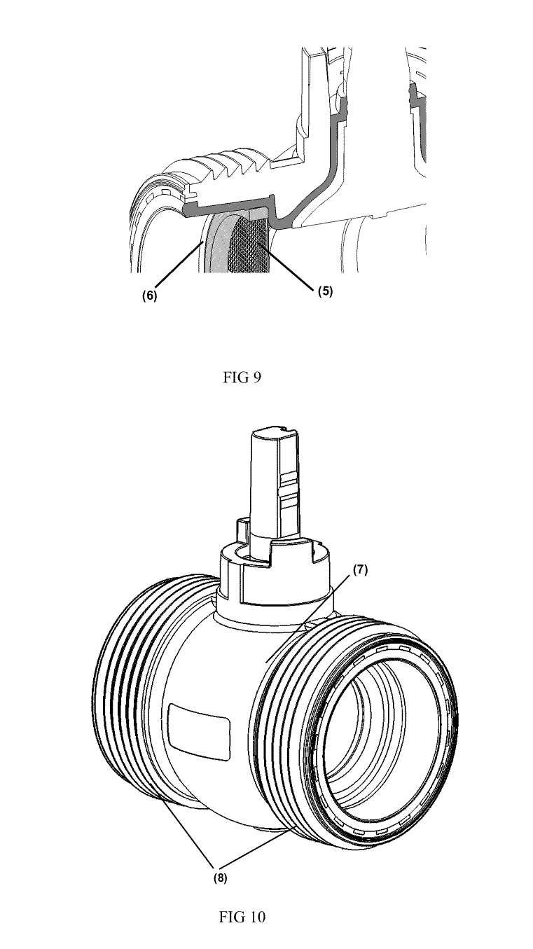

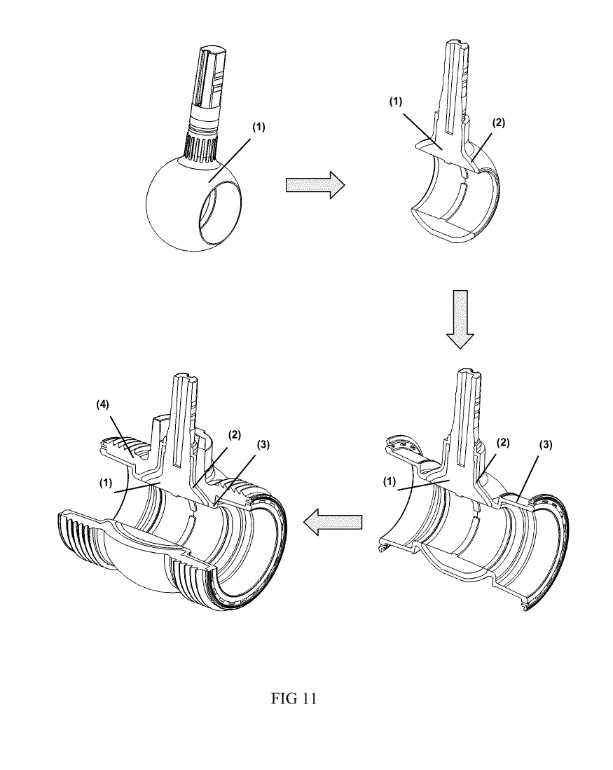

The valve body is the component involving all other components and it will be injected in the last stage of our sequential process. Its geometric shape is based on a central spherical shape (7) that extends to the ends by two cylindrical branches (8) wherein the connections of the tubes are linked and the nuts are clamped. The shape of the spherical central geometry is due to the ball that operates in its interior. The spherical shape (7) allows a higher mechanical resistance of the set. The cylindrical branches (8) are the extension of the valve body to the tubes wherein thread for the valve nut clamping are provided, see FIG. 10.

Features

The main innovative features of the present monoblock valve are:

a) a smaller number of components due to overmoulding and assembly inside the moulds of the basic valve components;
b) the introduction of ball filling element (core) thus allowing the sequential injection to obtain a uniform wall thickness in the ball, therefore avoiding its ovalness;
c) introduction of a stage in the process wherein a slip-type innocuous lubricating substance is inserted;
d) integration of an interior reinforcement;
e) Integration of a single sealing element in TPE material—injected thermoplastic elastomer;
f) the fast coupling/connecting system of the tube, using universal nuts for every connection;
g) the fast maintenance/substitution of the monoblock valve;
h) a reduction of the components, as well as the valve's size and weight (less raw material) due to overmoulding and assembly inside the moulds;
i) the introduction of an anti-particle filter inside the valve body;
a) Overmoulding and assembly of the valve components inside the injection moulds

In spite of the fact that ball valves are already known both technically and commercially, this particular invention provides innovations in the manufacture process thereof, presenting many advantages when compared to conventional valves. In valves currently available in the market the pieces (i), (ii), (iii), (iv), shown in FIG. 3, are individually manufactured and are subsequently assembled to form the final product. As a result of requiring a larger amount of components and additional assembly procedures, this solution implies in itself higher costs, increasing the valve's production time when compared to the foreseen monoblock valve.

The manufacture process of the disclosed monoblock ball valve, is based on the sequential injection of the four main components that form the solid body of the valve, wherein each subsequent component is injected on the previous one thus involving it, as shown in FIG. 11. In the end of the four moulding steps, a single solid and inseparable body is obtained.

Several methods can be used to mould a monoblock ball valve. A possible method uses a plastic injection mould with four rotative cores (moulding areas) wherein each component is injected and transferred to the next cavity for overmoulding the following component during the opening/closing operation of the mould.

For instance, in a hypothetical initial moment “t0” the first ball filling element is injected (1) in cavity no. 1 of the mould. The mould opens and the transfer of this component to cavity no. 2 occurs which will inject, in moment “t1”, the ball on the filling element injected in the previous cycle. In this precise moment “t1” a new filling element is also formed. By opening the mould, the pieces (1) and (2) are transferred to cores no.2 and no.3 respectively, due to the rotation of the respective cores.

In moment “t2” the overmoulding of components (2) and (3) occurs, as well as the injection of a new filling element (1). New plug rotation takes place while opening of the mould and, finally, in moment “t3”, the overmoulding of components (2), (3) and (4) occurs as well as a new filling element is produced in the cavity no.1. In this moment the monoblock valve body is complete and a complete valve will be produced in each new cycle, since simultaneous mouldings occur in all 4 cores of the mould.

According to the present invention, this is the method that enables an actual manufacture of monoblock ball valves in thermoplastic materials, being however other processes possible, wherein the transfer of the presented components, from one cavity to another, inside the same mould or in different moulds, it carried out according to the principle presented in FIG. 11.

Another method that can be used to produce a monoblock valve, includes the use of robots to transport the components that compose the valve body from one cavity to its subsequent. In this case, the robot may transfer the components among the four cores of a same mould or between the cores of four different moulds, wherein each mould produces one of the components that compose the monoblock valve. It is obvious that the transporting procedure of components (1), (2) and (3) from one cavity to another could be carried out manually by the injection machine operator.

Therefore, independently of the placement of the components in the cores for the subsequent overmoulding, the real innovation of this process resides in the fact that the monoblock valve is based on the overmoulding principles of its components, with the purpose of producing a monoblock valve, in other words, a single body valve with integrated functionality (ball rotation inside the valve) in a complete assembly process of the components inside their own injection moulds. This is impossible of being rendered in the current process of valve production.

A further alternative, in any of the 2 methods previously described, the ball filling element (1) integrated with the valve control stem can be produced by different methods, such as:
Lost-core injection moulding wherein a spherical core made with a low melting-point alloy, is placed inside the mould's cavity to shape the interior of the ball;
Another method would be the introduction of mechanisms inside the mould, such as retractile cores, to shape the interior of the ball;
gas or water assisted injection, with resource to an inert gas or water, it is possible to inject highly thick components, wherein the external wall of the component is compact while its interior is hollow;
The use of foaming or nucleating agents is another valid method, with the objective to inject thick components with a compact plastic external film and a foamy interior core (9). This injection technique can set out another situation, wherein the ball filling element will integrate itself the ball (the thickness of the ball being added, see illustration 12). This situation would lead to the elimination of a stage in the process, the ball injection. The thickness of the ball would be integrated with the ball filling element, integrating all functionalities of the two components. This integration is in itself possible mainly due to the injection with an foaming agent, which would lead to a reduction in production costs, both of machinery and raw material consumption, which would be clearly beneficial for the new integral assembly concept.

Still another alternative foresees these being injected in the traditional method and receiving surface finishing procedures for imperfection removal, being later assembled to the sealings and overmoulded with the valve body, forming a single body.

Part of the thickness of the filling element (1) spherical body can be at any time substituted by an equivalent component produced in a material that might be later removed, such as: a low melting-point metal, a polymer soluble in acid or other substance, aiming however to reduce the ball's (2) thickness.

The process further integrates a rotative system for the ball (2) inside the mould of the valve body (4). This system operates by the end of the injection of the last component, the valve body (4), when it is still warm, turning the ball in the valve, still inside the mould, enabling the functionality of the ball and also keeping it from adhering to the sealing because of temperature effect.

The innovation resides in carrying out this operation inside the injection mould. Therefore, after injecting the body and having the component still inside the mould, a ball rotative mechanism, for the ball is actuated. By introducing this operation inside the last injection mould, we are innovating and optimizing the production tools' functionalities. The mould which was mainly responsible for injecting the body and simultaneously promoting the assembly of all other valve components, will also undertake another functionality, in this case the validation of the valve rotation.

The option of integrating as many operations/functionalities inside a single tool as possible, in this case in an injection mould, is certainly an innovative and differentiating concept.

The operation principle of the rotative system of the valve is based on rotating the ball (2), similar to when the lever handle is placed and rotated, as previously shown (see sequence A/B/C in FIG. 13).

In order to carry out this operation a hydraulic cylinder (15) was placed in the mould which makes the rack (16) rise and lower, which will in turn drive a toothed wheel (17), associated with a rotative core (18) that fits in the lever handle's stem spike. By actuating the hydraulic cylinder (19), that moves the rack upwardly and downwardly, moving enough to complete a quarter turn of the toothed wheel and consequently of the rotative core on the stem. Thus the ball is allowed to rotate inside of the mould (20) (21) (22), while still hot. This operation will be repeated several times, until a sufficient cooling state of the component is reached to extract of the mould.

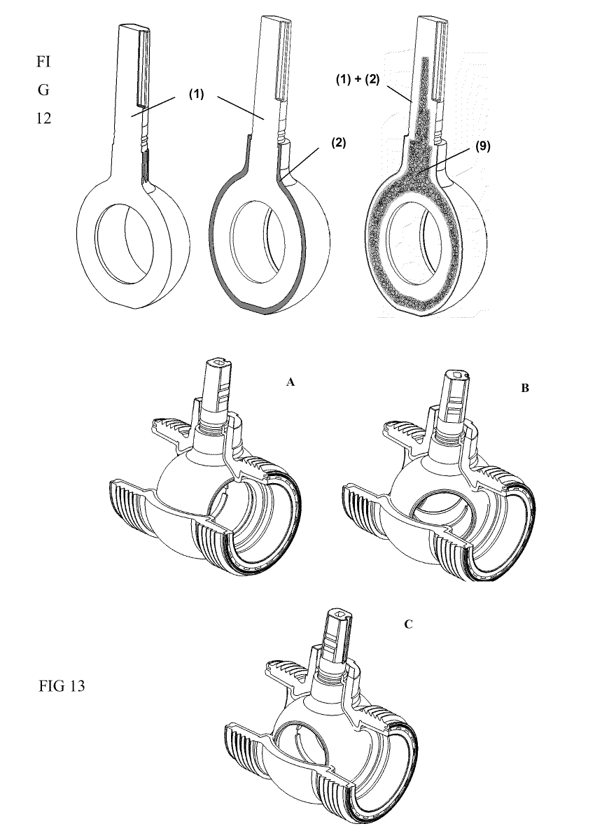

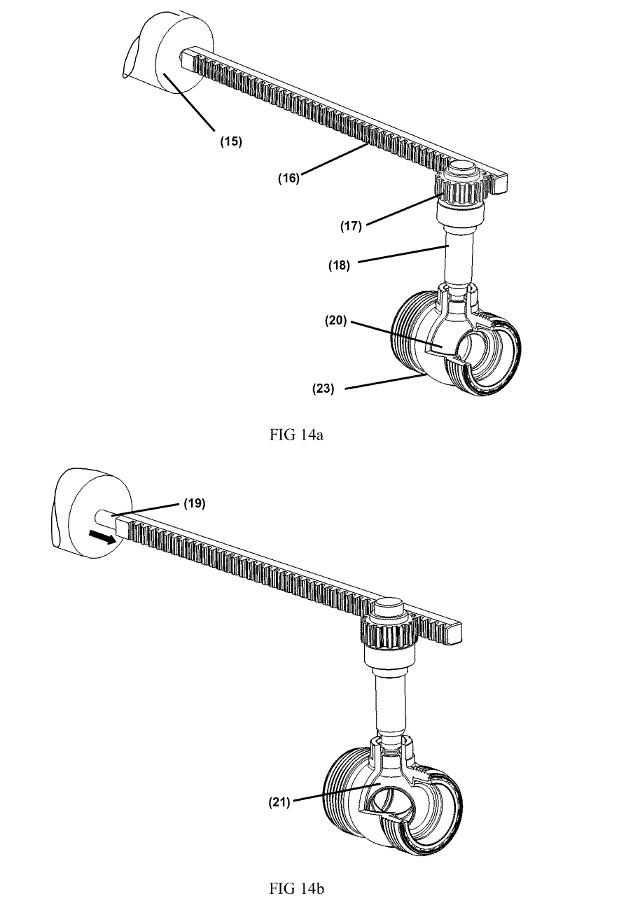

FIGS. 14a, 14b and 14c list all system components (including the monoblock valve by the end of the body (23)

Injection stage) besides illustrating the entire operation of the rotative mechanism of the ball (20), (21), (22).

b) Injection sequencing - homogenization of the ball's thickness

In currently available conventional ball valves, the balls (2) are typically injected separately, being generally followed by a surface finishing procedure, usually with lathe operations, to remove imperfections in its spherical surface which result from factors inherent to the injection process, mould construction or other situations that might compromise the sealing between the ball (2) and the ball's sealing (3). The process herein described eliminates this auxiliary operation (surface finishing), which is costly in terms of machinery.

In order to obtain a perfect sealing between these two components, the sealing surfaces of these components must be placed in all contact areas so as to avoid that under-pressure the liquid escapes amidst these surfaces and eventually instigates leakages. There are many factors that might compromise the sealing quality among the ball (2) and the ball's sealing (3):
Differentiated contractions (shrinkage) caused by thickness differences in the component;
Unbalanced cooling wherein the component suffers from differential contractions;
Low injecting or compacting pressures;
Different contraction rates for components made of different plastic materials;
Imperfections in the mould's partition lines;
edges, among others.

In order to overcome such problems and to obtain a roundness that gives way to a good sealing, it has been sought to maintain a ball wall thickness (2) as homogeneous as possible. This is obtained due to ball filling element (1) which removes thickness from the ball maintaining it as homogeneous as possible within the acceptable roundness tolerances.

Moreover special attention was drawn to the placement of the mould's partition lines for the said components so that the ball rotation is not compromised or interrupted around its axis, during the valve's actuation.

The moulds' partition line (x) will be preferentially placed in order to allow the ball component to rotate without causing any interference with the sealing area. Should this interference occur, it would be caused by a possible flashing formation in the mould's joint, which could damage the sealing area. The partition line (x) will be preferentially placed along the ball body in a central position to the diameter of the ball and aligned in the direction of the flow opening, see FIG. 15. When the ball is rotated, it will present its partition line transversally to the valve's rotation axis.

Provided that the ball filling element will be the first to be injected in this position, all other moulds will have the same partition line disposition in order to allow an easy automation of the process and manipulation of the components by the robots.

Another innovation applied in the set filling element/ball is the incorporation of the stem in the filling element, which is a separate component in conventional valves.

Another concern to take into account is the fact that the ball (2) and the ball's sealing (3) are manufactured with different materials: ball in POM or PP, sealing in TPE, EPDM or PUR to avoid that the chemical affinity among equal materials, provokes welding between the ball and the sealing, due to high temperatures among the contact surfaces of these components, during the injection process of the sealing (3) over the ball (2). Since the materials are different and POM or PP do not have any affinity with TPE, EPDM or PUR a superficial welding will not occur. The ball (2) will be able to slide towards the sealing (3) during the valve's actuation.

More specifically, the method can be used for any type of thermoplastic or thermosetting, provided that the processing temperatures and material chemical affinities respect the criteria of each overmoulding procedure. So being, for the first moulding of the ball filling element (1) the material in question might be Polypropylene (Homo, Glass, Random), PVC, PVDF, PPSU, PSU, ABS, POM, PEx, etc.

In the second moulding of the ball (2) a certain chemical affinity must be observed between the first material and the material now injected. In this component one can use the same list of materials above presented. However one should point out, that the ball filling element and the ball will probably be made of the same material.

The third component, the single sealing element in TPE (3) is unlike the others a thermoplastic rubber known as TPE (thermoplastic elastomer). For its formulation, there are countless compositions that might have thermoplastics or thermosettings based matrix, such as Polypropylene (PP), Polyethylene (PE), Polyester (UP), Polyamide (PA), silicone (SI) and Polyurethane (PUR). In the present case, we have a TEEE polyester based thermoplastic rubber (Thermoplastic polyester elastomer). These injectable rubbers have a high mechanical resistance and a good performance at service temperatures up to 120° C.

On the fourth moulding the valve body (4) will be injected. This should be made of a material with good mechanical, chemical and thermal characteristics. Once again we present the same list: PVC-U, PVC-C (chlorinated), PVDF, PP-H, PP-R, PP-R+30% GF, PP-CRT, ABS, PSU, etc.

The valve body is the component that will have to support all components of the valve and simultaneously promote the valve functionality together with the ball and sealing.

c) However, as the sealing element contracts when cooling down, thus creating a compression tension on the ball (2), this might hinder the sliding of the ball towards the ball sealing (3) during the valve's actuation. Consequently, this difficulty will be overcome should it occur, submitting the ball (2) to a bath, in a volatile product and/or in an slip-type antiadherent substance that will deposit a lubricated layer of some hundredths of a millimetre before the sealing element (3) is moulded over the sphere (2). This volatile substance must be innocuous and it will work as a buffer allowing the sealing to contract on this thin layer, which by volatizing will allow the rotation of the ball (2) inside the sealing (3). Preferably, the lubricating film will be placed on the ball during the transfer of the component to the mould which will inject the sealing element, to give way for the ball to rotate with minimal adherence inside the valve.

d) the solution found to overcome the problem of excessive contraction of the valve body (4) over the sealing element, is the introduction of two elements designated internal body reinforcements (24a) and (24b) (assembled on the sealing element, which by working as an internal shield don't give way for the valve body (4) to excessively contract on the sealing element. This shield retains the whole contraction of the valve body (4) allowing the valve internal structure to be reinforced without considering the abutment pressure between the ball and sealing surfaces.

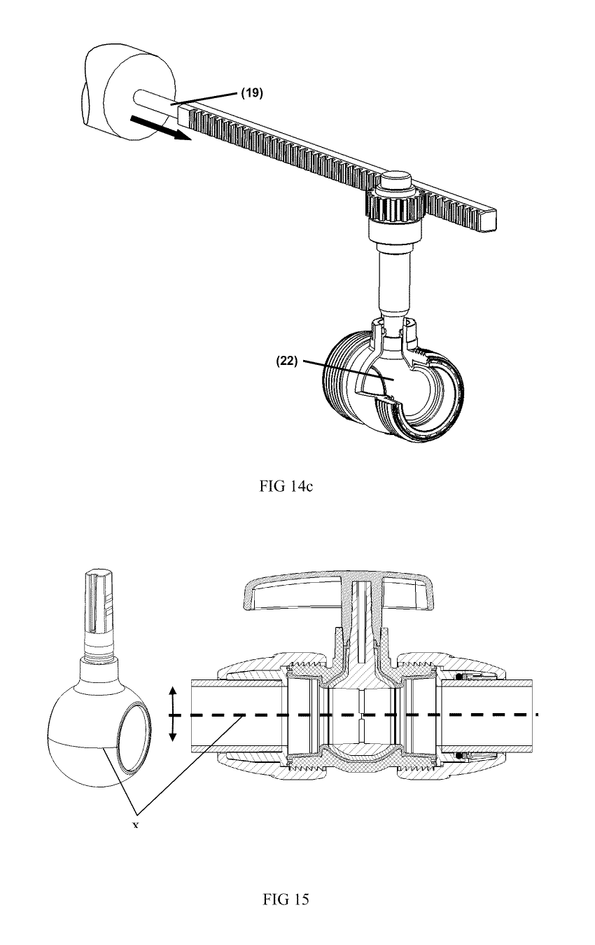

FIGS. 16a and 16b illustrate different embodiments of such reinforcement, a more conventional implementation, with sealing placement and reinforcement assembly (highlighting the ball seats (25) and the core with assembled reinforcements (26)) and integrated assembly, wherein the reinforcement is already placed on the single sealing element overmoulded in the previous stage (the sealing element (3) having assembled reinforcements (27)).

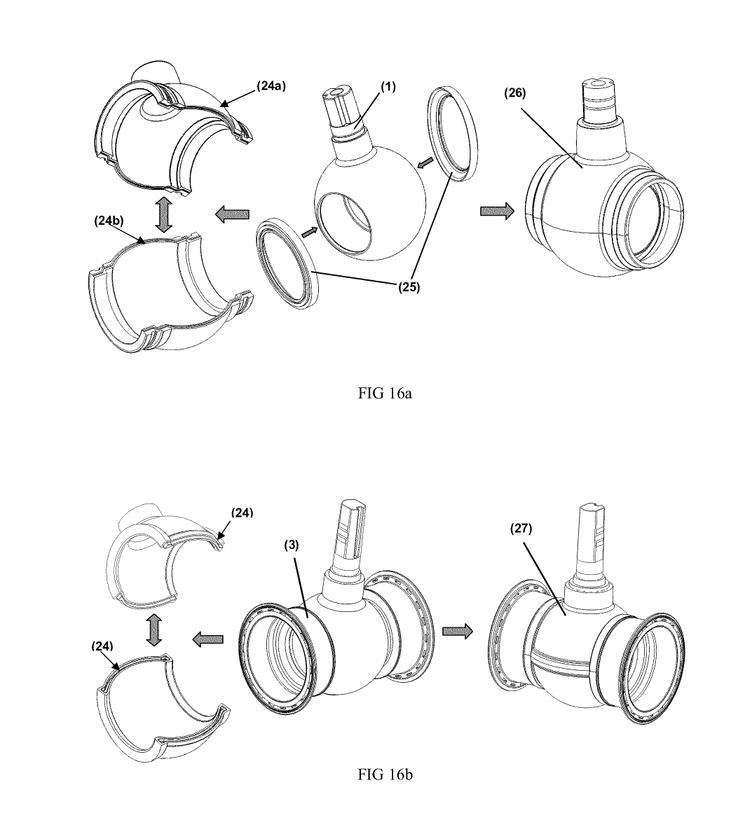

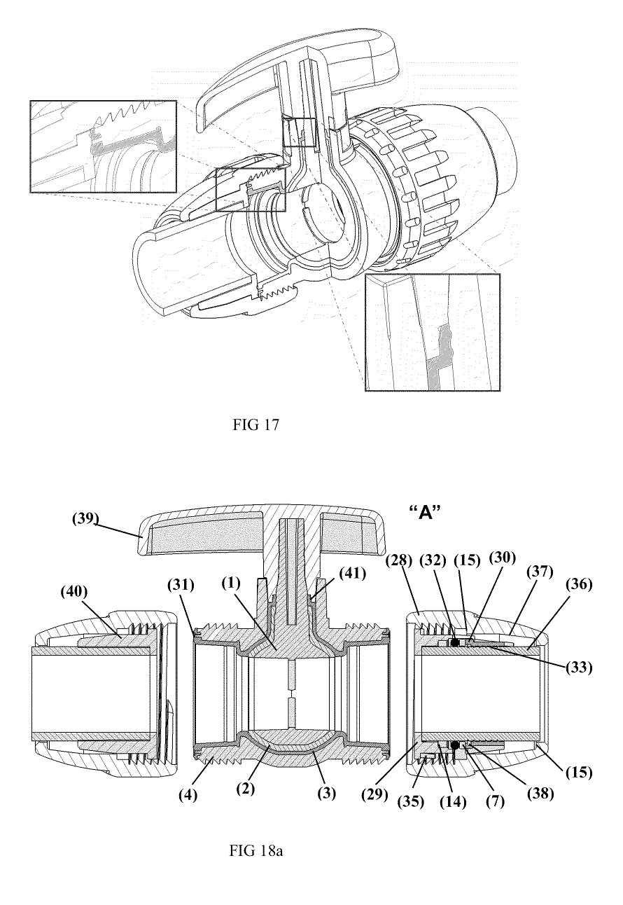

e) on the other hand, the sealing element will be designated single sealing element, taken that unlike conventional valves, the sealing element covers the whole ball and the whole internal chamber of the valve where the liquids flow, thus allowing a more effective sealing (sealing along the whole ball surface). On the other hand, the single sealing extends to the outer edge of the valve body, both in the upper area by stem and on the side wherein the connectors are adjusted. The sealing element therefore endorses the sealing in the stem area and also in the abutment area of the connectors, eliminating four o-rings as evidently illustrated in FIG. 17.

f) Quick coupling system for tube using a monoblock valve. A hydraulic ball valve may typically be used together with several accessories, usually connecting hard or flexible tubes or hoses by means of diverse processes such as: screwing, gluing, thermal welding, ultrasonic welding, thermofusion, quick coupling, among others. FIG. 18a illustrates an example of the assembly of accessories for quick coupling (on the right) and coupling with thermal welding connectors (on the left) for monoblock valves.

Another proposed improvement concerns the assembly of the monoblock valve with quick coupling accessories in flexible and semi-rigid tubes or hoses. In these coupling types the tolerance variation in the tube or hose diameter is relatively high, which makes it difficult to obtain an efficient sealing effect.

In order to absorb this tolerances variation in the tubes, a system comprising three components was projected: clamping nut (28), abutment element of the sealing (29) and tube clamping element (30), as shown in FIGS. 18A, 18B and 18C.

This system comprises in its inlet and outlet:

An essentially annular-shaped abutment element of the sealing (29), comprising a recto radial abutment surface which receives the end of the tube in its interior and abuts to the valve body (4) close to the end (31) of the single sealing element (3) and has a longitudinal extension to hold the o-ring 32) and tube clamping element (30);
an o-ring (32) that is assembled in the grove of the abutment element of the sealing (29);
a tube clamping element (30), essentially conical and annular-shaped and extending longitudinally comprising teeth (33) in the interior surface and a slot (34) projected in order to reduce its diameter and to absorb variations in the tubes' diameter; and
An essentially annular-shaped clamping nut (28) extending longitudinally which comprises an interior thread in one end that will promote the coupling to the valve body (4), as well as a conical interior surface which by being clamped, presses the abutment element of the sealing (29) against the wall (31), being simultaneously the o-ring (32) forced to abut to the bottom of the abutment element of the sealing (32), simultaneously, the tube clamping element (30) is also pressed so as to press the teeth (33) against the tube.

This system operates as follows: initially the o-ring is assembled (32) in the box of the abutment element of the sealing (29) and afterwards the abutment element of the sealing (29) is assembled, according to FIG. 18A. Next, tube clamping element (30) is concentrically fit in the clamping nut (28).

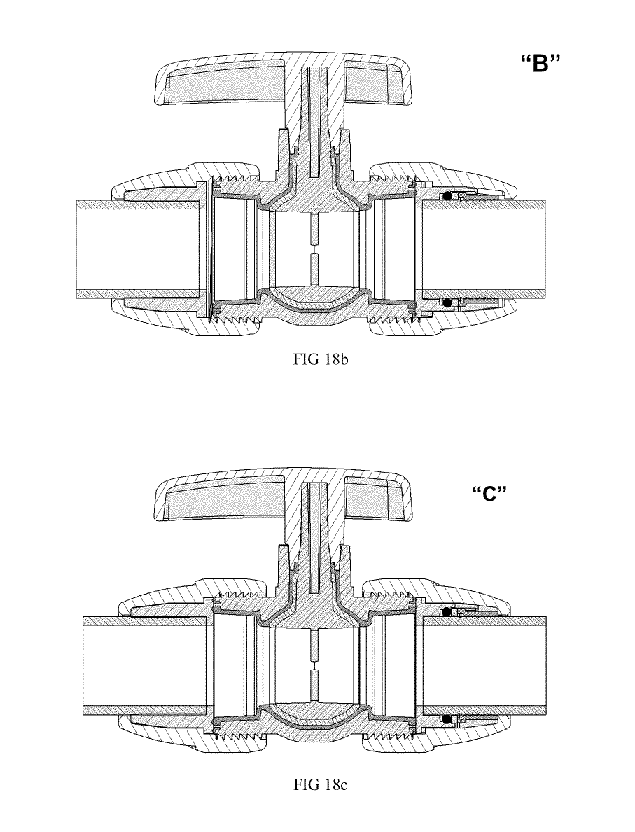

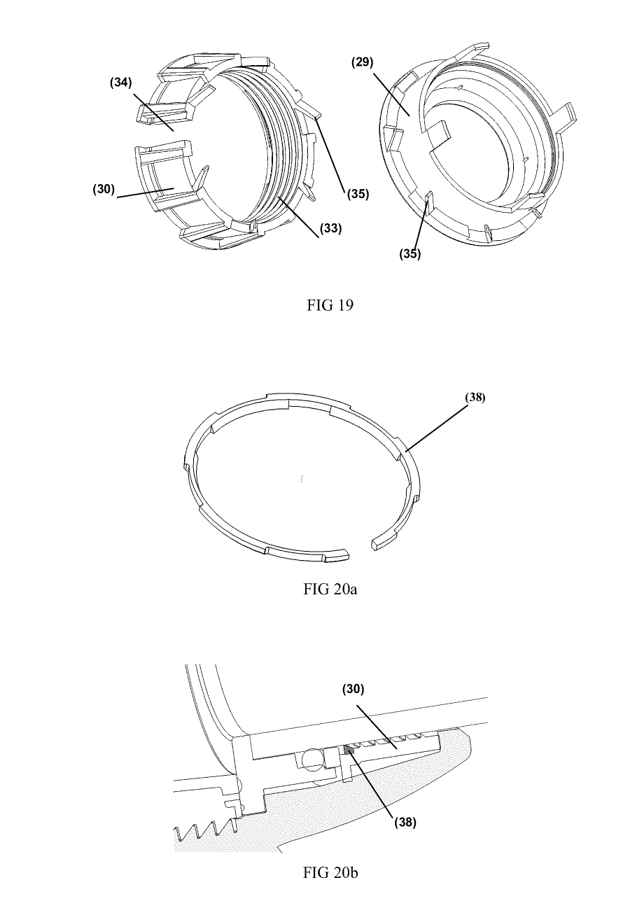

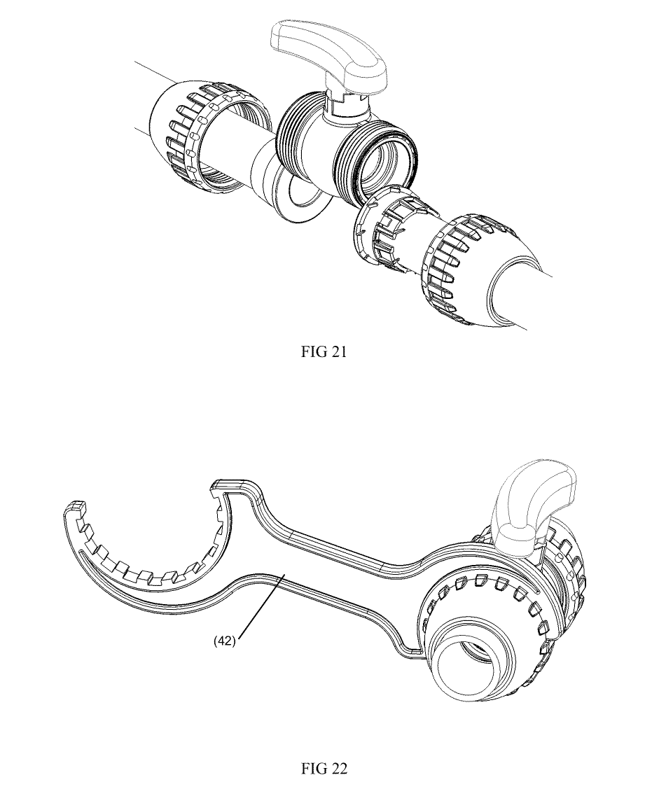

The nut is than rotated (one or two threads) so that the o-ring (32) and the abutment element of the sealing (29) are not pressed yet. Soon after, the tube is introduced until it leans on the bottom surface of the abutment element of the sealing (29), as shown in FIG. 18a. The clamping of nut (28) proceeds until reaching position “B” as shown in the illustration 18b, so that the element (29) is adjusted and pressed against the sealing (3) wall (31), resulting in a complete sealing even before the clamping nut (28) is totally twined. This is the result of the innovation implemented in the tube clamping element (30) and in the abutment element of the sealing (29), mainly by means of abutment tabs (35), illustrated in FIG. 19. The tube (36) is in its turn held by the teeth (33) of the tube clamping element (30) which by being forced by the clamping nut's cone when moving inwards, moves the o-ring (32) to a retention box, thus allowing a perfect sealing with the tube (36).

Since the abutment tabs have a flexibility which is adjusted to their performance, these must be resistant enough in order not to bend until the o-ring (6) is in its final sealing position on the tube. However, the abutment tabs might be fragile enough so that from their position “B” in FIG. 18b, as the clamping nut (28) is further twined and through the conical surface (37), they force the tube clamping element (30) to close, thus clamping the teeth (33) against the tube wall, so that it is fixed inside the valve. Position “C” is then reached, as shown in FIG. 18c. This is possible mainly due to the construction of the tube clamping element (30) which presents a slot (34) projected to give way to a reduction in its diameter and thus absorb the tubes diameter variations.

The geometric form of the tube clamping element (30) has a longitudinal opening slot (34) that allows its diameter to vary depending on the diameter of the tubes or hoses, besides, the conical surface in this component makes it possible for the wall (37) of the clamping nut (28) to push the teeth (33) forcing them to penetrate in the tube surface.

The tube clamping element (30) has the appointed set of flexible abutment tabs (35′) that allow the components (29) and (6) to be pressed against the wall (31) and to adjust the tube before the nut reaches the end of its course. By further twining the clamping nut (28), a movement is produced on the tube clamping element (30) which clamps the teeth (33) against the tube, since the longitudinal movement is absorbed by the abutment tabs flexion (35′).

The abutment element of the sealing (29) also has some abutment tabs (35) to promote and to ensure the abutment of this component to the valve wall (31).

The integration of a metal washer (38), which substitutes one of the teeth of the tube clamping element (30) allows the fixation/indentation of tubes made of rigid material, such as PVC. This washer has the geometry of a tooth and when used together with the tube clamping element (30) it will clamp rigid tubes, commonly used in high-pressures applications (FIG. 20).

Therefore, from the resulting geometric shape of the tube clamping element (30) shown in FIG. 19, two important features are guaranteed:
The abutment element of the sealing leanes against the wall (31) of the valve body (4) ensuring the sealing between the tube and the valve body, even if the tube clamping nut (28) doesn't reach its final position (that is, even before the whole distance is traveled), thus absorbing the tube diameter variations;
It begins and finalizes the clamping of tube during its course, despite traveling the whole distance, due to diameter variations in tubes currently available.

Unlike the valves currently available, the fixation of the tube (36) doesn't occur simultaneously with the tightness of the o-ring (32), but first it guaranteed the sealing, with the clamping of the abutment element of the sealing against the valve body wall (31) and only then occurs the closing movement of the component (29) pressing the tube and arresting it inside the valve while moving the o-ring to its sealing position with the tube.

g) The conception of the monoblock valve and its coupling/connection systems to the tube is such, that a quick substitution of the valve body (central area) might occur without interfering with the pipe system, being mainly necessary unscrewing the nuts (28) and slide the valve body between the connectors (see FIG. 21). This is due to the fact that none of the connecting components are introduced inside de valve body, they remain instead leaned to the valve body, thus allowing a substitution should the valve be harmed. The fact that the pipe system remains untouchable is a very important factor that increases the products advantages.

The quick maintenance/substitution is an imposed requirement by the consumer society. Nowadays, the repairs of this type of products are no longer carried out, being the products substituted for new ones when damaged. So being, the entire system must be framed facing its rapid substitution when one of its components fails.

The valve herein provided has an accessory, a nut socket wrench (42) presenting different sizes, according to the nuts' dimension. The wrenches are conceived to integrate two nut sizes per wrench. The wrench offers a perfect adjustment to the nut and consequently an easier nut clamping and unbolting. Nowadays, adjustable gib-head keys are used which frequently damage the clamping slots of the nut.

h) Innovative features: a lesser number of components, produces a more compact product, comprising a substantial weight reduction and consequently material reduction without compromising its mechanical features, it offers a clear optimization in design for an enhanced handling and assembly ergonomics, consequently also standing out for its universal implementation to the tubes and for the simplicity of its implementation in pipe systems.

The classical ball valves in thermoplastic material are a clear example of a product that requests large labor for its assembly, since they consist of a large number of components. Based on the analysis of the conventional valves currently available, it has been verified that the component amount of the valves varies from 17 to 21 components, which have to be assembled after being purchased from suppliers. The creation of a product with fewer components is somewhat revolutionary, because it offers a more compact product and a low-cost component management. The effortlessness assembly of the product's few components reduces significantly the assembly process, the costs being almost trivial and coupling and assembly elements being avoided, such as screws, nuts, cramps, quick fitting springs, etc. On the other hand, the whole logistics inherent to component storage and distribution becomes a lot less visible in the final costs of the product.

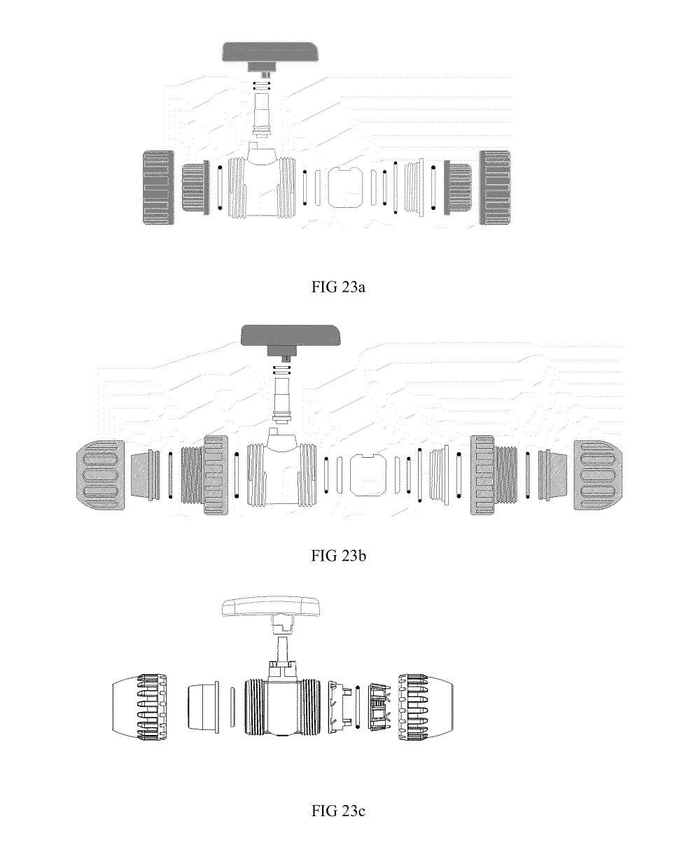

This new valve concept foresees a reduction of 7 to 11 components comparing to the currently available existent products, enabling great optimization of logistics, manufacture and storage costs. So being, the product currently available has different components integrated in its body: the ball (1), the stem (1), the stem o-rings (2), the ball seat o-rings (2), the ball sealing seats (25), the o-rings for the tube connectors (2), the body cover (1) and the body (1). In some situations, however, the component reduction might not be as evident, see FIGS. 23a, 23b and 23c.

The new concept concerning the single sealing element's universality, besides promoting an efficient sealing on the entire ball surface, it also promotes the sealing in the connectors' area (31) and in the upper area of the valve stem (41) where the handle is assembled, eliminating a total of seven o-rings.

The simple assembly without an excessive amount of components per valve, enables the valve component to remain integral, free from any component loss during the assembly procedure. On the other hand, a smaller quantity of components also assists the assembly process significantly.

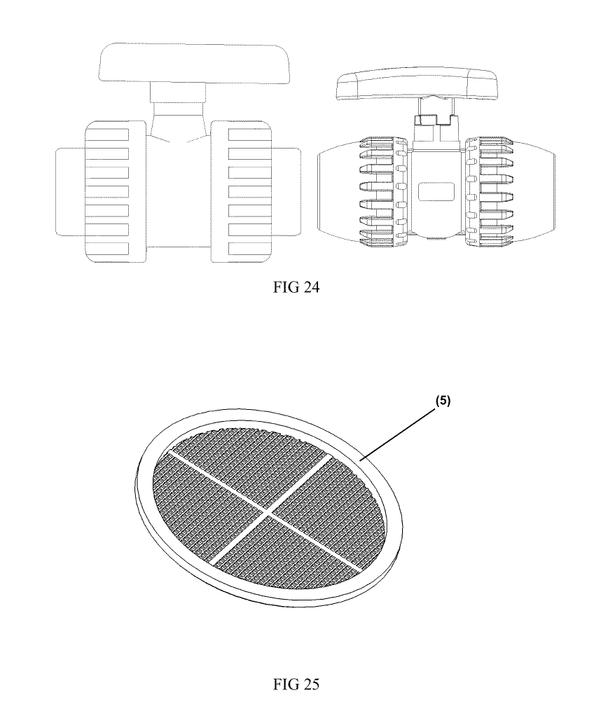

The valve herein presented has a compact and less intrusive design, thus reducing the space required for its housing in the pipe system. This provides smaller housings in pipe system as well as a simpler handling by assembly or maintenance technicians. The design is pleasant and select, letting the product maintain the inner shape of the ball and spread it to the external lines of the valve body, the design of the product then becoming more appealing and organic. The new design also provides a reduction in the valve weight and size (reduction of plastic material), without compromising the mechanical. Therefore, a substantial reduction was verified merely in the valve body component. As an example, we present the currently available valves comprising a size 40, with an outer diameter of 80 mm, while the monoblock valve herein provided presents an outer diameter of 65 mm, as clearly illustrated in FIG. 24.

A more compact and single body-type design (monoblock), improves the product's performance when under pressure, being pressure values between PN 16 and PN 25 set as goals, even for larger dimensions. Presently, the market offers products conceived for nominal pressures between PN10 and PN20.

Unlike conventional valves that provide different systems for a certain coupling type, comprising different clamping nuts (see FIGS. 23a and 23b), the valve herein disclosed provides a single nut (see illustration 23c) that can be used both in conventional systems such as gluing, welding and threading, and in quick coupling systems and thermofusion, giving this new valve concept a more universal implementation. In the case of conventional valves and for the quick coupling, there is always the need to integrate a proper “set” in each end of the valve to foster such kind of clamping. The set consists of special connectors, quick clamping nuts, tube clamping elements and o-ring. This set is visibly illustrated in FIG. 23b.

i)the introduction of a antiparticle filter (5) inside the valve body is another innovation that improves the whole system's performance, see illustration 25. This can optionally be introduced in the valve body, depending on the implementation type and requirements thereof. The filter will be firmly fixed to the valve body by a half-round hongs.

It should be highlighted that the previously described embodiments of the monoblock ball valve are mainly possible implementation examples, merely set for a clear understanding of the invention's principles. Variations and alterations might be made to the said embodiments without substantially straying from the scope of the invention. All modifications and variations must be included in the scope of the invention and protected by the following claims.

1. A manufacture method of monoblock ball valves, wherein its components are overmoulded onto each other in a mould with several cores or in successive moulds, forming a single and solid body, comprising sequence injection moulding, wherein each subsequent component is injected onto the previous component thus involving it, wherein the following components are moulded at least in the following order:
A ball filling element with a valve control stem;
A ball which is moulded onto the ball filling element;
A single sealing element which involves the ball and the inside of the valve, also promotes the sealing at the stem and at the valve's inlet and outlet area; and
A valve body.

2. The manufacture method according to claim 1, wherein the ball filling element integrated with the stem is produced by methods such as: lost-core injection, by introducing mechanisms in the mould such as retractile cores, gas or water assisted injection, by using foaming or nucleation agents or even being injected and submitted to surface finishing procedures to remove imperfections, being later assembled into the sealings and overmoulded with the valve body, thus forming a single body.

3. The manufacture method according to claim 1, wherein the ball being integrated with the ball filling element, produced by methods such as: gas or water assisted injection, or using foaming agents allowing the combination in a single piece, the ball and the ball filling element, eliminating a component of the process.

4. The manufacture method according to claim 1, wherein the overmoulded ball has an uniform thickness, preferably a thickness between 2.5 mm to 3 mm, which doesn't compromise its mechanical performance.

5. A manufacture method according to claim 1, wherein the ball and filling element, are manufactured by the following processes: as lost-core injection, by introducing mechanisms in the mould such as retractile cores, gas or water assisted injection or by using foaming or nucleation agents wherein the ball filling element is replaced by an equivalent piece produced in material that can later be removed, such as: low melting-point metal or soluble polymers with the aim of removing thickness from the ball.

6. The manufacture method according to claim 1, further comprising a rotative mechanism of the valve ball inside the injection mould of the valve body and wherein the rotation of the ball is carried out, even still in hot conditions.

7. The manufacture method according to claim 6, wherein the rotative mechanism of the valve ball inside the injection mould of the valve body consists of a hydraulic cylinder that is fixed in the lower side of the mould, a rack that drives the toothed wheel (connected to the piston rod of the hydraulic cylinder already inside the mould), an associated toothed wheel (driven by the rack) and finally the rotative core associated with the toothed wheel, that promotes the connection of the stem, thus rotating the ball.

8. The manufacture method according to claim 1, wherein an innocuous and volatile substance or a slip-type antiadherent mould-removable substance is applied around the ball when the component passes from the ball into the mould that will inject the sealing element.

9. The manufacture method according to claim 1, wherein internal reinforcements and are introduced over the sealing element or over the ball seats.

10. The manufacture method according to claim 1, wherein the partition line (x) of all moulds, is placed in a central position to the diameter of the ball body and aligned in the direction of the fluid's passage opening.

11. Monoblock ball valve manufactured according to the method of claim 1, comprising at least the following components:
a ball filling element with a valve control stem, which has an essentially spherical shape with a cylindrical channel whose axis crosses the ball centre and is essentially transversal to the control stem's axis;
a ball with a hollow spherical shape that involves the ball filling element;
a single sleeve-type sealing element involving the entire ball and the whole internal part of the valve, comprising two cylindrical-section openings coincident to the inlet and outlet areas of the valve body, the said sleeve having a sealing element opening in the area involving the diameter of the stem; and
a valve body with an essentially cylindrical hollow shape, comprising inlet and outlet areas in its ends and a radial opening in the middle of the body for the rolling passage of the stem, wherein quick coupling systems are provided both in the inlet and outlet areas.

12. The valve according to claim 11, wherein the quick coupling systems of the valve body comprise in its inlet and outlet areas:
an abutment element of the sealing with an essentially annular shape comprising a recto radial abutment surface which receives the end of the tube in its interior and abuts it to the valve body close to the end of the sealing element, and has a longitudinal extension to hold the o-ring and the tube clamping element;
an o-ring that is assembled in the grove of the abutment element of the sealing;
a tube clamping element, essentially conical and annular-shaped and extending longitudinally, comprising teeth in the interior surface and a slot projected in order to reduce its diameter and to absorb variations in the tubes' diameter; and
an essentially annular-shaped nut extending longitudinally which comprises an interior thread in one end that will promote the coupling to the valve body as well as a conical interior surface which by being clamped, presses the abutment element of the sealing and the o-ring against the wall and the tube clamping element close so as to press the teeth against the tube.

13. The valve according to claim 11, wherein the longitudinal movement of the nut is absorbed by flexible abutment tabs located in the contact area with the abutment element of the sealing and also by flexible abutment tabs in the end of tube clamping element.

14. The valve according to claim 11, wherein the tube clamping element comprises a metal washer, that substitutes one of its teeth and carries out fastening/indentation of hard tubes, in high-pressure applications.

15. The valve according to claim 11, further comprising an anti-particle filter inside the valve body.

16. The valve assembly according to claim 12, further comprising the following stages:
assembling up the o-ring in the grove of the abutment element of the sealing;
assembling the tube clamping element in the abutment element of the sealing
slipping on the tube clamping element in the nut;
starting the nut clamping such that the o-ring and the abutment element of the sealing are not yet pressed;
introducing the tube until it leans against the bottom surface of the abutment element of the sealing;
proceeding with the nut clamping until the abutment element of the sealing is adjusted and pressed against the wall of the sealing.

17. The valve according to claim 11, wherein the convectional coupling system of the valve body comprise in the inlet and outlet areas:
an essentially annular-shaped end-element (connector) extending longitudinally, wherein the tube is attached by gluing, welding, threading or thermofusion, which receives the end of the tube in its interior and leans against the valve body at the end of the sealing element;
an essentially annular-shaped nut extending longitudinally, which comprises an interior thread in one end that will promote the coupling to the valve body, as well as an interior surface corresponding to the shape of the end-element of the tube.

18. The valve according to claim 11, wherein the ball filling element and the ball are made of a material consisting of a certain chemical affinity, preferably Polypropylene, PVC, PVDF, PPSU, PSU, ABS, POM and PEx.

19. The valve according to claim 11, wherein the single sealing element is made of a TPE—thermoplastic elastomer, with compositions that might have thermoplastics or thermosettings as base matrix, such as Polypropylene (PP), Polyethylene (PE), Polyester (UP), Polyamide (PA), Silicone (SI) and Polyester (UP), preferably TEEE polyester based thermoplastic rubber.

20. The valve according to claim 11, wherein the valve body is made of PVC-U, PVC-C, PVDF, PP-H, PP-R, PP-R+30% GF, PP-CRT, ABS, PSU, PPSU, PE, PEx, POM, PPO, or others.
